(19) United States
(12) Patent Application Publication
(10) Pub. No.: US 2024/0273614 A1
(43) Pub. Date: Aug. 15, 2024

(54) METHODS AND SYSTEMS FOR SIMULATING A VEHICLE SEAT IN A VEHICLE USING AUGMENTED REALITY

(71) Applicant: STATE FARM MUTUAL AUTOMOBILE INSURANCE COMPANY, Bloomington, IL (US)

(72) Inventors: Catherine Espel-Logan, Plano, TX (US); Brian Mark Fields, Phoenix, AZ (US); Joshua John Freitas, Peoria, AZ (US); Melissa Collette Miles, Normal, IL (US); Jeanne Koehler, Bloomington, IL (US)

(21) Appl. No.: 18/416,273

(22) Filed: Jan. 18, 2024

Related U.S. Application Data
(60) Provisional application No. 63/541,659, filed on Sep. 29, 2023.
(60) Provisional application No. 63/530,418, filed on Aug. 2, 2023.
(60) Provisional application No. 63/524,035, filed on Jun. 29, 2023.
(60) Provisional application No. 63/488,042, filed on Mar. 2, 2023.
(60) Provisional application No. 63/445,879, filed on Feb. 15, 2023.

(51) Int. Cl. G06Q 30/0601; H04N 21/472

(52) U.S. Cl. CPC G06Q 30/0643; G06Q 30/0621; G06Q 30/0631; H04N 21/47217

(57) ABSTRACT

Systems and methods for simulating a vehicle seat in a vehicle using augmented reality. The systems and methods overlay a virtual vehicle seat model associated with a physical vehicle seat onto a physical vehicle via a display of the viewer device to generate a virtual configuration of the virtual vehicle seat model in the physical vehicle.

### CROSS-REFERENCE TO RELATED APPLICATIONS

This application claims priority to and the benefit of the filing date of provisional U.S. Patent Application No. 63/445,879 entitled “METHODS AND SYSTEMS FOR SIMULATING A VEHICLE SEAT IN A VEHICLE” filed Feb. 15, 2023; provisional U.S. Patent Application No. 63/488,042 entitled “METHODS AND SYSTEMS FOR AUTOMATED VEHICLE SEAT REPLACEMENT,” filed on Mar. 2, 2023; provisional U.S. Patent Application No. 63/524,035 entitled “METHODS AND SYSTEMS FOR AUTOMATED MACHINE VISION MONITORING OF VEHICLE SEATS,” filed on Jun. 29, 2023; provisional U.S. Patent Application No. 63/530,418 entitled “METHODS AND SYSTEMS FOR GENERATING, MAINTAINING, AND USING INFORMATION RELATED TO VEHICLE SEATS STORED ON A BLOCKCHAIN,” filed Aug. 2, 2023; and provisional U.S. Patent Application No. 63/541,659 entitled “METHODS AND SYSTEMS OF USING AUGMENTED REALITY FOR VISUALIZING THE PROPER FASTENING OF A VEHICLE SEAT,” filed Sep. 29, 2023, the entire contents of which is hereby expressly incorporated herein by reference.

### FIELD OF THE INVENTION

The present disclosure generally relates to simulating a vehicle seat in a vehicle, and, more particularly, generating the simulation of the vehicle seat using augmented reality.

### BACKGROUND

Choosing a vehicle seat, such as a car seat or booster seat for a child or infant, and installing the vehicle seat in a vehicle may be a confusing and time-consuming task. Someone may purchase a car seat only to realize it is an inappropriate size for a vehicle once they attempt to install it, requiring them to inconveniently spend time and effort returning the vehicle seat, only to risk the possibility the same thing will occur with the next vehicle seat they attempt to install.

Even if the vehicle seat does fit the vehicle, it may be challenging to easily determine the best configuration of the vehicle seat within the vehicle without having to awkwardly place and remove an oftentimes large and cumbersome vehicle seat in and out of the vehicle several times.

Additionally, once a preferred configuration is decided upon, the vehicle seat must then be installed in the vehicle, which often may require reading a set of instructions to determine how to properly attach the hardware of the vehicle seat to the hardware of the vehicle. These installation instructions may include generic information, which may not accurately translate to installing the specific model of vehicle seat in the specific vehicle in which the installation is being attempted. As such, vehicle seats may be installed inappropriately-creating risks to persons or animals placed in the vehicle seat.

The conventional seat installation techniques may include additional ineffectiveness, inefficiencies, encumbrances, and/or other drawbacks.

### SUMMARY

The present embodiments may relate to, inter alia, systems and methods for simulating a vehicle seat in a vehicle. The systems and methods may include simulating a physical vehicle seat in the physical vehicle using augmented reality (AR) and/or virtual reality (VR) (and/or mixed reality (MR) or eXtended reality (XR)). The simulation may include (i) a virtual configuration of one or more virtual vehicle seat models overlaid on a physical vehicle using augmented reality, and/or (ii) a virtual configuration of one or more virtual vehicle seat models and a virtual vehicle model using virtual reality.

In one aspect, a computer-implemented method for simulating a vehicle seat in a vehicle using augmented reality (AR) (or VR, MR, or XR) may be provided. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice or chat bots, ChatGPT bots, and/or other electronic or electrical components, which may be in wired or wireless communication with one another. In one instance, the computer-implemented method may include (1) receiving, by one or more processors, a vehicle indicator associated with a physical vehicle; (2) determining, via the one or more processors, a field of view of a viewer device associated with a user; (3) based upon the field of view, determining, by the one or more processors, a position of the physical vehicle relative to the user; (4) receiving, by the one or more processors, a physical vehicle seat indicator; (5) obtaining, by the one or more processors, a virtual vehicle seat model associated with the indicated physical vehicle seat; and/or (6) based upon the position of the physical vehicle, overlaying, via the one or more processors, the virtual vehicle seat model onto the physical vehicle via a display of the viewer device to generate a virtual configuration of the virtual vehicle seat model in the physical vehicle. The method may include additional, less, or alternate functionality or actions, including those discussed elsewhere herein.

In another aspect, a computer system for simulating a vehicle seat in a vehicle using augmented reality (AR), virtual reality (VR), mixed reality (MR), and/or extended reality (XR) may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice or chat bots, ChatGPT bots, and/or other electronic or electrical components, which may be in wired or wireless communication with one another. In one instance, the computer system may include one or more processors and one or more non-transitory memories storing processor-executable instructions that, when executed by the one or more processors, may cause the system to (1) receive a vehicle indicator associated with a physical vehicle; (2) determine a field of view of a viewer device associated with a user; (3) based upon the field of view, determine a position of the physical vehicle relative to the user; (4) receive a physical vehicle seat indicator; (5) obtain a virtual vehicle seat model associated with the indicated physical vehicle seat; and/or (6) based upon the position of the physical vehicle, overlay the virtual vehicle seat model onto the physical vehicle via a display of the viewer device to generate a virtual configuration of the virtual vehicle seat model in the physical vehicle. The computer system may include additional, less, or alternate functionality, including that discussed elsewhere herein.

In another aspect, a non-transitory computer-readable medium storing processor-executable instructions that, when executed by one or more processors, may cause the one or more processors to (1) receive a vehicle indicator associated with a physical vehicle; (2) determine a field of view of a viewer device associated with a user; (3) based upon the field of view, determine a position of the physical vehicle relative to the user; (4) receive a physical vehicle seat indicator; (5) obtain a virtual vehicle seat model associated with the indicated physical vehicle seat; and/or (6) based upon the position of the physical vehicle, overlay the virtual vehicle seat model onto the physical vehicle via a display of the viewer device to generate a virtual configuration of the virtual vehicle seat model in the physical vehicle. The instructions may direct additional, less, or alternate functionality, including that discussed elsewhere herein.

Additional, alternate and/or fewer actions, steps, features and/or functionality may be included in some embodiments and/or embodiments, including those described elsewhere herein.

### BRIEF DESCRIPTION OF THE DRAWINGS

The figures described below depict various embodiments of the applications, methods, and systems disclosed herein. It should be understood that each figure depicts one embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1A depicts a block diagram of an exemplary AR device;

FIG. 1B depicts a block diagram of an exemplary VR device;

FIG. 2 depicts a block diagram of an exemplary computer system in which methods and systems for simulating a vehicle seat in a vehicle are implemented;

FIG. 3A depicts a block diagram for simulating a vehicle seat;

FIG. 3B depicts a block diagram for simulating a vehicle seat using AR;

FIG. 3C depicts a block diagram for simulating a vehicle seat using VR;

FIG. 3D depicts an exemplary virtual configuration to obtain a PVS (physical vehicle seat) indicator;

FIG. 3E depicts an exemplary VR virtual configuration of installation instructions;

FIG. 4 depicts a flow diagram of an exemplary computer-implemented method for simulating a vehicle seat in a vehicle using AR; and

FIG. 5 depicts a flow diagram of an exemplary computer-implemented method for simulating a vehicle seat in a vehicle using VR.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

The computer systems and methods disclosed herein generally relate to, inter alia, using augmented reality (AR), virtual reality (VR), mixed reality (MR), and/or extended reality (XR) for virtually simulating and installing a vehicle seat in a vehicle. As it is generally used herein, the term “vehicle seat” refers to a seat placed upon the seats included by the original equipment manufacturer (OEM) of the vehicle, such as car seats and/or booster seats for infants and/or children, and kennels and/or other types of vehicle seats for pets.

As used herein, the term augmented reality (AR) may refer to generating digital content (i.e., a virtual configuration) which is overlaid on a view of the user's physical environment via a display of a viewer device, such as on a transparent surface of a viewer device, such that a wearer/user of the AR viewer device (which may include AR glasses or headsets) is still able to view their physical environment. The virtual configuration may include virtual images, text, models, sounds, animations, videos, instructions, multimedia and/or other digitally-generated content.

As used herein, the term virtual reality (VR) may refer to generating digital content which is presented via a display of a viewer device, which may not include a transparent surface nor a direct view of one's physical environment. This may include virtual images, text, models, sounds, animations, videos, instructions, multimedia and/or other digitally-generated content via the display of the viewer device (which may be a VR headset or glasses), wherein the display may be a screen such as an OLED screen. The viewer device may present the virtual configuration via the display of the viewer device, which may include a virtual simulation and/or digital recreation, of the physical environment.

As used herein, the term mixed reality (MR) may refer to a viewer device which is capable of displaying both AR and/or VR content. The terms AR, VR and/or MR may be used interchangeably herein.

As used herein, the term viewer device may refer to a device having a display which may be capable of presenting virtual configurations using AR and/or VR techniques.

Some embodiments may use AR and/or VR techniques to assist a user in visualizing the vehicle seat. This may include creating a virtual vehicle seat model (VVSM) associated with a physical vehicle seat (PVS). In one AR embodiment, the VVSM may be overlaid onto a physical vehicle (PV), such as a vehicle owned by the user, in a virtual configuration presented to the user via the display of a viewer device. In one VR embodiment, this may include generating a virtual vehicle model (VVM) which is associated with the PV and simulating the VVSM and the VVM in a virtual configuration which is presented via the display of a viewer device to a user.

In one embodiment, the VVSM may simulate one or more configurations and/or installation positions of the VVSM within the PV in an AR embodiment, and/or within a VVM in a VR embodiment. In one embodiment, the virtual configuration may include displaying virtual content associated with the fit of the PVS within the PV based upon the associated virtual configuration of the VVSM within the PV and/or VVM.

In some embodiments, installation of the VVSM within the PV or VVM may be simulated using AR or VR techniques respectively, which may include step-by-step installation instructions comprising sound, text, images, models, animation, video, multimedia and/or other digitally-generated content, as well as any other instructions suitable to simulate installation of a VVSM.

### Exemplary AR Device

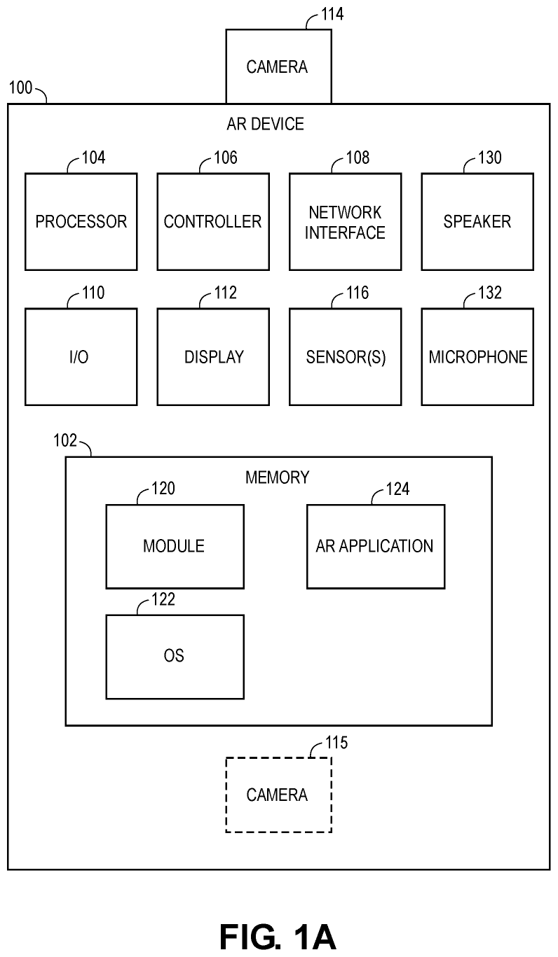

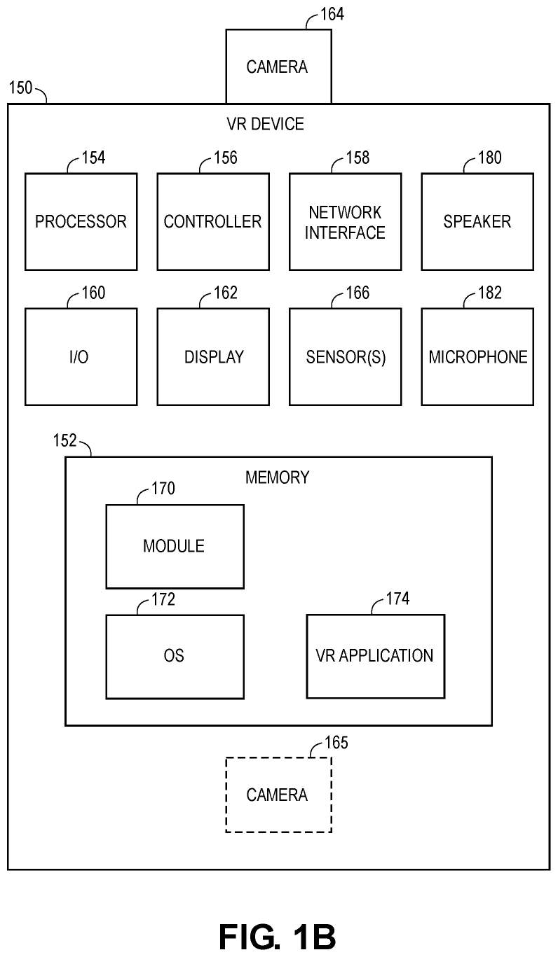

Referring the drawings, FIG. 1A depicts an exemplary AR device 100 that may implement the techniques described herein, for simulating a vehicle seat. The AR device 100 may be, for example, a smartphone, tablet device, laptop computer, electronic contact lenses, a projector, glasses, googles, a headset such as the Google Glass, an MR headset such as the Microsoft HoloLens, and/or other suitable computer device.

The AR device 100 may include a memory 102, a processor (CPU) 104, a controller 106, a network interface 108, an I/O 110, a display 112, cameras 114, 115, sensors 116, a speaker 130 and/or a microphone 132.

The memory 102 may include one or more memories, such as a non-transitory, computer readable memory comprising computer-executable instructions that, when executed, cause the AR device 100 to perform actions thereof described in this description (e.g., via the processor 104, controller 106, display 112 and/or other components of the AR device 100). The memory 102 may comprise one or more memory modules 120 such a random-access memory (RAM), read-only memory (ROM), flash memory, a hard disk drive (HDD), a solid-state drive (SSD), flash memory, MicroSD cards, and/or other types of suitable memory.

The memory 102 may store an operating system (OS) 122 (e.g., Microsoft Windows Mixed Reality Platform, Linux, Android, iOS, UNIX, etc.) capable of facilitating the functionalities, applications, methods, or other software as discussed herein. Memory 102 may also store one or more applications to, e.g., simulate a virtual vehicle seat. In one embodiment, memory 102 may store an AR application 124 which may, among other things, present virtual configurations to the display 112 of AR device 100 as described in more detail herein.

Additionally, or alternatively, the memory 102 may store data from various sources, e.g., user indications of a PV, VVM, PVS, and/or VVSM, virtual configurations, installation instructions, virtual models, as well as any other suitable data.

The processor 104 may include one or more local or remote processors, which may be of general-purpose or specific-purpose. In some embodiments this may include one or more microprocessors, ASICs, FPGAs, systems-on-chip (SoCs), systems-in-package (SiPs), graphics processing units (GPUs), well as any other suitable types of processors. During operation, the processor 104 may execute instructions stored in the program memory module 102 coupled to the processor 104 via a system bus of a controller 106.

The AR device 100 may further include the controller 106. The controller 106 may receive, process, generate, transmit, and/or store data and may include and/or be operably connected to (e.g., via the system bus) the memory 102, the processor 104, and/or the I/O 110, as well as any other suitable components.

The AR device 100 may further include a network interface 108, which may facilitate communications to and/or from the AR device 100 with one or more devices and/or networks, such as a server. The network interface 108 may include one or more transceivers and/or modems, and may facilitate any suitable wired or wireless communication, standard or technology, such as GSM, CDMA, TDMA, WCDMA, LTE, EDGE, OFDM, GPRS, EV-DO, UWB, 3G, 4G, 5G, IEEE 802 including Ethernet, WiMAX, Wi-Fi, Bluetooth, and/or other suitable communication.

The I/O 110 (i.e., one or more input and/or output units) may include, interface with and/or be operably connected to, for example, one or more input devices such as a touchpad, a touchscreen, a keyboard, a mouse, a camera 114, 115, and/or microphone 132, as well as one or more output devices such as a display 112, a speaker 130, a haptic/vibration device, and/or other suitable input and/or output devices. In some embodiments, the I/O 110 may include one or more peripheral I/O devices, such as a peripheral display, microphone 132, camera 114, 115, sensors 116 and/or other interface devices operably connected to the AR device 100 (e.g., via a wired or wireless connection) via the I/O 110. Although FIG. 1A depicts the I/O 110 as a single block, the I/O 110 may include a number of different I/O circuits, busses and/or modules, which may be configured for I/O operations.

One or more cameras 114, 115 may capture still and/or video images of the physical environment of the AR device 100. The cameras 114, 115 may include digital cameras, such as charge-coupled devices, to detect electromagnetic radiation in the visual range or other wavelengths. In some embodiments, as depicted in FIG. 1A, one or more interior cameras 115 may be located on the interior of the AR device 100, e.g., for eye tracking of the user via OS 122 and/or AR application 124. The AR device 100 may include one or more exterior cameras 114 located on the exterior of AR device 100, e.g., for user hand tracking, object identification, and/or localization within the physical environment via OS 122 and/or VR application 124. In other embodiments, one or more of the cameras (not shown) may be external to, and operably connected with (e.g., via I/O 110, Bluetooth and/or Wi-Fi) the AR device 100. The captured images may be used to generate virtual configurations, augmented environments, overlays and the like. In some embodiments, two or more cameras, such as external cameras 114, may be disposed to obtain stereoscopic images of the physical environment, thereby better enabling the AR device 100 to generate virtual space representations of the physical environment, and/or overlay augmented information onto the physical environment.

The display 112, along with other integrated or operably connected devices, may present augmented and/or virtual information to a user of the AR device 100, such as a virtual configuration. The display 112 may include any known or hereafter developed visual or tactile display technology, including LCD, LED, OLED, AMOLED, a projection display, a haptic display, a holographic display, or other types of displays. In some embodiments, the display 112 may include dual and/or stereoscopic displays, e.g., one for presenting content to the left eye and another for presenting content to the right eye. In some embodiments, the display 112 may be transparent allowing the user to see the physical environment around them, e.g., for implementing AR techniques in which a virtual configuration may be overlaid on the physical environment.

According to one embodiment of FIG. 1A, the AR device 100 may present one or more virtual configurations via the display 112. For example, the display 112 may be a surface positioned in a line of sight of the wearer of the AR device 100. Accordingly, the AR device 100 may be configured to overlay augmented information included in the virtual configuration onto features of the physical environment within the line of sight of the wearer of the AR device 100. To determine the line of sight of the wearer, the AR device 100 may include an image sensor (such as an external camera 114) configured to have a field of view that generally aligns with the line of the sight of the wearer. In one embodiment, the AR device 100 may be configured to route the image data to the processor 104, such as a server, to generate a virtual configuration that includes information related to objects within the line of sight of the wearer in a manner that is accurately overlaid on the physical environment.

The AR device 100 may further include one or more sensors 116. In some embodiments, additional local and/or remote sensors 116 may be communicatively connected to the AR device 100. The sensors 116 may include any devices or components mentioned herein, other devices suitable for capturing data regarding the physical environment, and/or later-developed devices that may be configured to provide data regarding the physical environment (including components of structures or objects within the physical environment).

Exemplary sensors 116 of the AR device 100 may include one or more accelerometers, gyroscopes, inertial measurement units (IMUs), GPS units, proximity sensors, cameras 114, 115 microphones 132, as well as any other suitable sensors. Additionally, other types of currently available or later-developed sensors may be included in some embodiments. One or more sensors 116 of the AR device 100 may be configured for localization, eye/hand/head/movement tracking, geolocation, object recognition, computer vision, photography, positioning and/or spatial orientation of the device, as well as other suitable purposes. The sensors 116 may provide sensor data regarding the local physical environment which may be used to generate a corresponding virtual configuration, as described herein, among other things.

In one embodiment, the AR device 100 or other device may process data from one or more sensors 116 to generate a semi-virtual environment. For example, data from one or more sensors 116, such as cameras 114, 115, accelerometers, gyroscopes, IMUs, etc., may be processed, e.g., at a server and/or at the AR device 100, which may include AR application 124, to determine aspects of the physical environment which may include object recognition, the orientation and/or localization of the AR device 100, the field of view of the user, among other things. In one embodiment, the sensor data may be combined with image data generated by the cameras 114, 115 to present virtual configurations via the display 112 of the AR device 100 using the AR application 124, which may include displaying and/or overlaying images, models, instructions, animations, video, multimedia and/or other digitally-generated content onto the physical environment via the display 112.

The AR device 100 may include one or more speakers 130 configured to emit sounds and one or more microphones 132 configured to detect sounds. The one or more speakers 130 and/or microphones 132 may be disposed on the AR device 100 and/or remotely from, and operably connected to, the AR device 100, e.g., via a wire and/or wirelessly. In one embodiment, the speaker 130 and/or microphone 132 may be configured to provide multimedia effects in conjunction with a virtual configuration, receive voice commands e.g., to control the AR device 100, among other things.

In some embodiments, the AR device 100 may be a personal electronic device, such as a smartphone or tablet. For example, the personal electronic device may be configured to execute the AR application 124 in which a rear-facing camera captures image data of the physical environment proximate to the AR device 100 and overlays AR data onto the display 112. Accordingly, in these embodiments, the functionality of the AR device 100 and/or the personal electronic device may be integrated at a single device.

In other embodiments, the AR device 100 may include a base unit coupled to an AR viewer device. For example, the base unit may be integrally formed with the AR viewer, such as in a frame that supports the display 112.

In other embodiments, the base unit and the AR viewer are physically separate and in wireless communication (e.g., via Bluetooth, Wi-Fi, or other short-range communication protocol) or wired communication with one another. In these embodiments, both the base unit and the AR viewer may include local versions of the components described with respect to the AR device 100. For example, both the base unit and the AR viewer may include respective memories 102, processors 104, controllers 106, network interfaces 108, and/or sensors 116. Accordingly, the respective memories 102 may include respective versions of the AR application 124 that coordinate the execution of the functionality described herein between the AR viewer and the base unit.

Generally, the AR application 124 may utilize the components of the base unit to perform the more processor-intensive functionality described with respect to the AR device 100. For example, the base unit may be configured to process sensor data, wirelessly communicate with a server, create virtual configurations, etc. On the other hand, the AR application 124 may utilize the components of the viewer device to transmit sensor data to present virtual configurations via the display 112.

The AR device 100 may include a power source (not shown), such as a rechargeable battery pack. The power source may be integral to the AR device 100 and/or may be a separate power source within the base unit and operably connected to the AR device 100.

The AR device 100 may include additional, fewer, and/or alternate components, and may be configured to perform additional, fewer, or alternate actions, including components/actions described herein.

### Exemplary VR Device

Referring the drawings, FIG. 1B depicts an exemplary VR device 150 that may implement the techniques described herein, for example simulating a vehicle seat and/or vehicle. The VR device 150 may be a smartphone, tablet device, laptop computer, a projector, a VR headset such as the Oculus Rift, an MR headset such as the Microsoft HoloLens, and/or another suitable computer device.

The VR device 150 may include a memory 152, a processor (CPU) 154, and a controller 156. The VR device 150 may further include a network interface 158, an I/O 160, a speaker 180 and/or a microphone 182. In some embodiments, components 152, 154, 156, 158, 160, 180 and 182 are configured to operate in the manner described above with respect to components 102, 104, 106, 108, 110, 130 and 132, respectively.

In one embodiment, the memory 152 may store a VR application 176 which may present virtual configurations to VR device 150. VR application 176 functionality may include analyzing data from one or more sensors 166, obtaining and/or generating virtual configurations, images, models, instructions, animations, video, audio, multimedia and/or other digitally-generated content (e.g., from a database on a server), presenting virtual configurations on the display 162 of the VR device 150, and/or providing interaction between the user and a virtual configuration, as well as any other suitable VR functionality.

The VR device 150 may include one or more displays 162. Along with other integrated or operably connected devices, the display 162 may present simulated and/or virtual environments to a user via a virtual configuration. The display 162 may include any known or hereafter developed visual or tactile display technology, including LCD, LED, OLED, AMOLED, a projection display, a haptic display, a holographic display, or other types of displays. In some embodiments, the display 162 may include dual and/or stereoscopic displays, e.g., one presenting content to the left eye and another presenting content to the right eye. In some embodiments, the display 162 may encompass the user's entire field of view such that the user is unable to see the physical environment around them creating an immersive, entirely virtual environment for the user.

The VR device 150 may further include one or more cameras 164, 165 which may capture still and/or video images of the user and/or physical environment. The one or more cameras 164, 165 may include digital cameras, stereoscopic cameras, and/or other similar devices, such as charge-coupled devices, to detect electromagnetic radiation in the visual range or other wavelengths. In some embodiments as depicted in FIG. 1B, one or more cameras may be an interior camera 165 located on the interior of the VR device 150 such as for eye tracking. In some embodiments, one or more cameras may be an exterior camera 164 located on the exterior of VR device 150 such as for hand tracking, localization within the physical environment, detecting objects in the physical environment e.g., which the user may unknowingly collide with due to the immersive nature of the display 112 to provide a warning, among other things. In other embodiments, one or more cameras may be external to, and operably connected with, the VR device 150 (e.g., via I/O 160, Bluetooth and/or Wi-Fi).

The VR device 150 may also include one or more sensors 166. The sensors 166 may include any devices or components described herein, other devices suitable for capturing data regarding a physical environment, and/or later-developed devices that may be configured to provide data regarding a physical environment (including components of structures or objects within the physical environment). The sensors 166 may be intended for localization, eye/hand/head/movement tracking, geolocation, object recognition, computer vision, photography, positioning and/or spatial orientation of the device, as well as other suitable purposes.

Exemplary sensors 166 of the VR device 150 may include one or more accelerometers, gyroscopes, inertial measurement units (IMUs), GPS units, proximity sensors, cameras 164, 165, microphones, 182, as well as any other suitable sensors. Additionally, other types of currently available or later-developed sensors may be included in some embodiments. In one embodiment, the VR device 150 may process data from one or more sensors 166 to generate an immersive, completely virtual environment for the user, which may include VR application 174 presenting the virtual configuration via the display 162 of VR device 150. For example, the virtual configuration may include the interior of virtual vehicle and the VR device 150 may use data from accelerometers, gyroscopes, IMUs to track the user's head movements so they may look around the virtual vehicle interior from various angles and points of view.

The VR device 150 of FIG. 1B may similarly include a base unit and power source (not shown) coupled to the VR device 150. The base unit may perform many of the functions described herein, as well as those explicitly described above similar to the AR device 100 base unit, such as creating the virtual configuration. The base unit may include other components, such as a processor, controller and/or sensors. Similar to the AR device 100, in some embodiments, the base unit may be part of the VR viewer, and in other embodiments the base unit may be separate from, but operably connected to (e.g., wirelessly or wired), the VR viewer such that the VR viewer may remain lightweight and comfortable for long-term use by the user. The present discussion assumes the base unit is integral and part of the VR viewer of VR device 150, unless otherwise described.

Additionally, the VR device 150 may be configured with other components and/or functionality described with respect to the AR device 100. The VR device 150 may include additional, fewer, and/or alternate components, and may be configured to perform additional, fewer, or alternate actions, including components/actions described herein.

### Exemplary Computer System

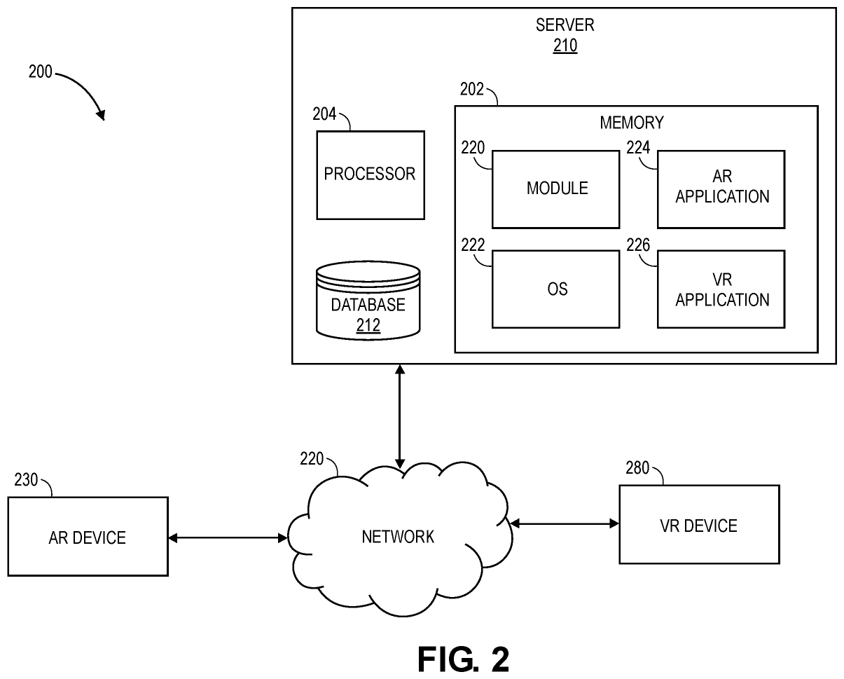

FIG. 2 depicts an exemplary computer system 200 in which the exemplary computer-implemented methods and systems as described herein may be implemented, for simulating a vehicle seat. The high-level architecture includes both hardware and software applications, as well as various data channels for communicating data between the various hardware and software components.

The system 200 may include an AR device 230 such as the AR device 100 of FIG. 1A, and a VR device 280 such as the VR device 150 of FIG. 1B. The AR device 230 and the VR device 280 may be configured to communicate with one or more servers 210 via one or more networks 220. Additionally or alternatively, the system 200 may include one or more MR or XR devices.

The network 220 of the system 200 may comprise one or more networks and facilitate any type of data communication via any standard or technology (e.g., 5G, 4G, 3G, GSM, CDMA, TDMA, LTE, EDGE, OFDM, GPRS, EV-DO, UWB, IEEE 802 including Ethernet, WiMAX, Wi-Fi, Bluetooth, and/or others). The network 220 may be a public network, such as the Internet or a cellular network, a private network such as a LAN, intranet or VPN, or any combination thereof. Accordingly, the network interface of the AR device 230 and the VR device 280 may be configured to implement the standards or technologies of the networks 220.

The exemplary system 200 may include one or more servers 210. In some embodiments, the servers 210 may be multiple, redundant, or replicated servers as part of a server farm or a cloud-based computing platform. For example, the servers 210 may include servers implemented by Microsoft Azure, Amazon AWS, or the like. The server 210 may include a memory 202, a processor 204, a memory module 220, OS 222, AR application 224 and VR application 226 which may be configured to operate in the manner described above with respect to the memories 102,152, the processors 104,154, memory modules 120, 170, OS 122, 172, AR Application 124 and VR application 174 respectively.

In some embodiments, the VR device 280 and/or the AR device 230 may have computing and/or power restrictions to keep the device portable, lightweight and comfortable, and provide sufficient battery-life for long-term use. Accordingly, the VR device 280 and/or the AR device 230 may be configured to offload computing to the server 210, such as processing sensor data and/or generating virtual configurations. This may be particularly likely when implementing VR techniques in which completely virtual environments are traversed by the user as compared to partially virtual environments.

The server 210 may include, or be operably connected to, a database 212 configured to store VVSMs and VVMs for presentation via a virtual configuration, as well as other suitable data. The VVSM may be a digital, three-dimensional virtual representation of the PVS. Similarly, a VVM may be a digital three-dimensional virtual representation of the PV. Generally, the VVSMs and VVMs may indicate physical characteristics and/or dimensions of a respective PVS or PV. Thus, the server 210, the AR device 230, and/or the VR device 280 may generate a virtual configuration that includes a virtual copy of PVSs and/or PVs in a manner which virtually reflects the physical dimensions of the PVSs and/or PVs. Accordingly, presenting the VVSM and/or the VVM in a virtual configuration may allow the user to virtually interact with a virtual model physically representative of a PVS, inter alia, moving it, resizing it and/or repositioning it in a virtual configuration without having to actually purchase and/or install a PVS in their vehicle. As a result, a user can avoid purchasing or otherwise obtaining a PVS that is not compatible with the user's PV.

In some embodiments, the VVSMs and/or VVMs may be provided by OEMs of the PVSs and PVs. For example, the OEM may scan the physical models of seats and vehicles and provide them to an operator of the server 210 and/or the database 212. As another example, the server 210 may generate the VVSMs and/or the VVMs based upon image data and/or specification sheets obtained from the internet or other online resources. As yet another example, if a VVSM for a PVS does not exist in the database 212, the server 210 may provide a user interface that enables the user to capture image and/or other dimensional data of the PVS. In this example, the server 210 may then analyze the received data to generate a 3D VVSM of the PVS.

In addition to the dimension data, the VVMs and/or the VVSMs may be associated with a set of installation instructions for the installing a PVS into a PV. The instructions may be obtained from the OEMs and/or from publicly-available product documentation. In some embodiments, the installation instructions are step-by-step instructions that include text and/or images of how to install the PVS.

As part of ingesting the instructions into the database 212, the server 210 may be configured to analyze the text and/or images included in the instructions and generate virtual animations that represent the described text. For example, the server 210 may convert an instruction to fasten a base of a PVS to an anchor to show the fastener of the PVS being attached into to the PV anchor. Accordingly, the VVSMs and the VVMs may also include annotations labeling portions of the model with text description commonly used in installation instructions. Thus, when converting the received instruction data into virtual animations, the server 210 is able to identify particular portions of the VVSMs and the VVMs to animate and/or display in a virtual configuration.

When implementing the disclosed AR techniques, the server 210 may receive sensor data from the AR device 230 via the network 220. The sensor data may indicate the user's field of view, a position of the user, distance from an object (e.g., a physical vehicle), images of the physical environments, pose of the user's head, among other things. The server 210 may process the sensor data, and based upon the sensor data, the sever 210 may generate a virtual configuration and/or retrieve a virtual configuration from database 212 to transmit to the AR device 230 for presentation via a display thereof. The AR device 230 may continuously and/or bidirectionally transmit data with the server 210 to process user inputs and/or interactions with the virtual configuration such that the VVSMs and/or augmented information overlaid on the physical environment is dynamically adjusted based upon the user's perspective and/or interactions with the virtual configuration.

According to another example, when implementing the disclosed VR techniques, the server 210 may receive data from VR device 280 via network 220. The data may include sensor data indicating images of the physical environment, pose of the user's head, and/or the location of hand controllers the user is holding, as well as a voice command data, e.g., to retrieve a virtual model of a vehicle. The server 210 may process the data to update the virtual configuration. For example, the server 210 may change a perspective and/or orientation of the virtual configuration visible via the VR device 280 based upon the sensor data. As another example, the server 210 may generate and/or retrieve a virtual configuration of a vehicle from database 212 to include in the virtual configuration.

The system 200 may include additional, fewer, and/or alternate components, and may be configured to perform additional, fewer, or alternate actions, including components/actions described herein.

### Exemplary Computer System for Simulating Virtual Vehicle Seat Installation

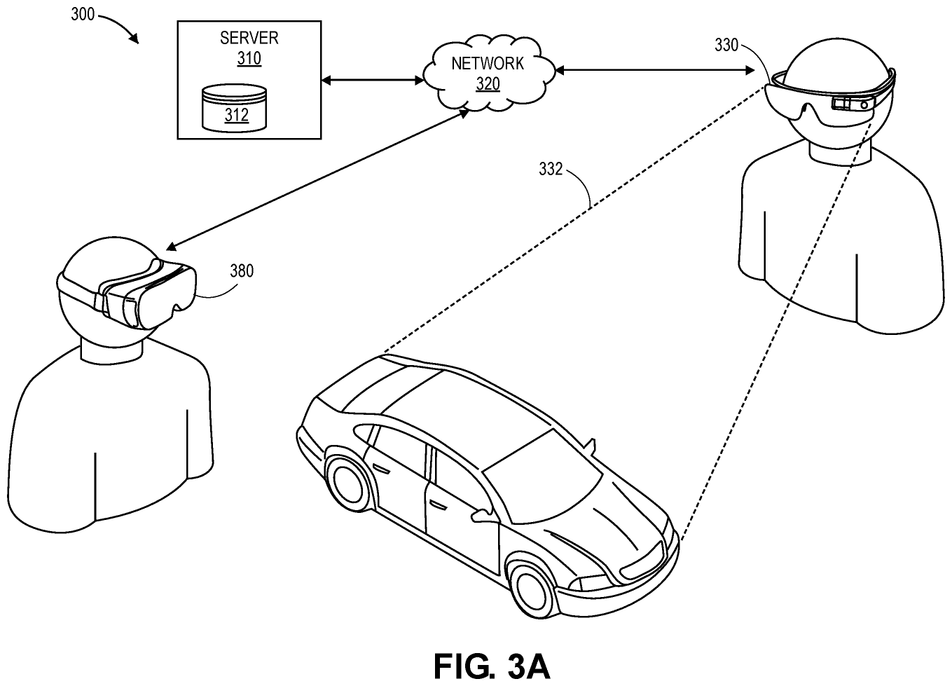

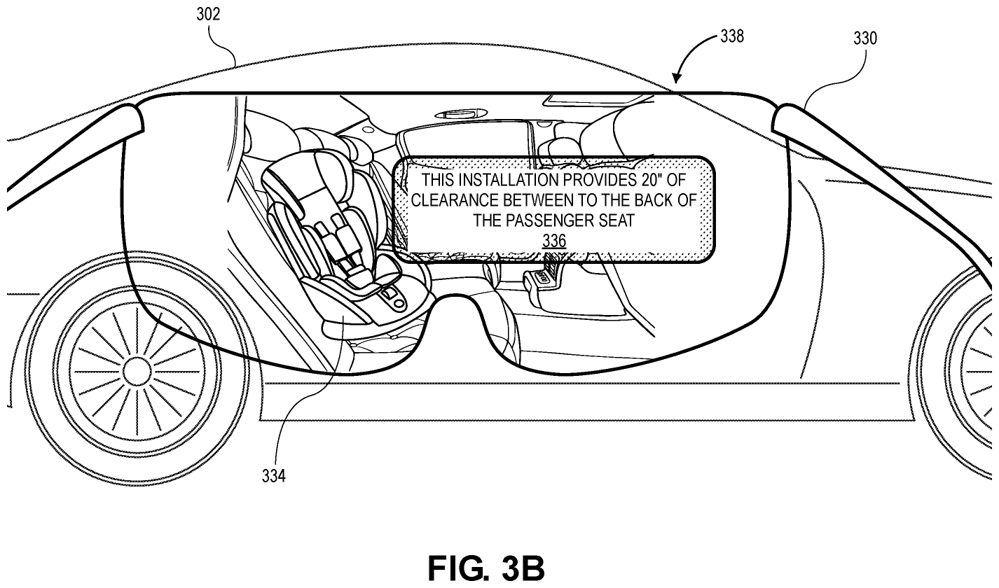

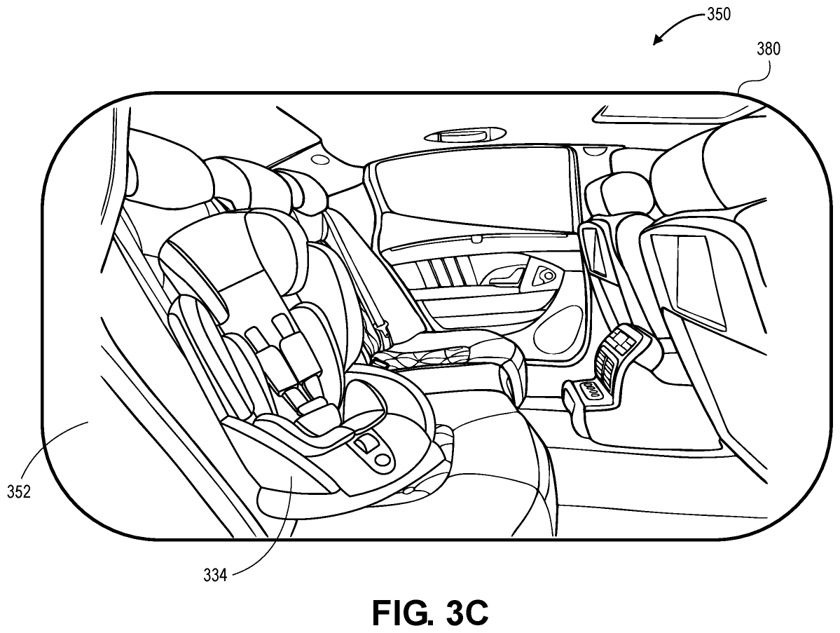

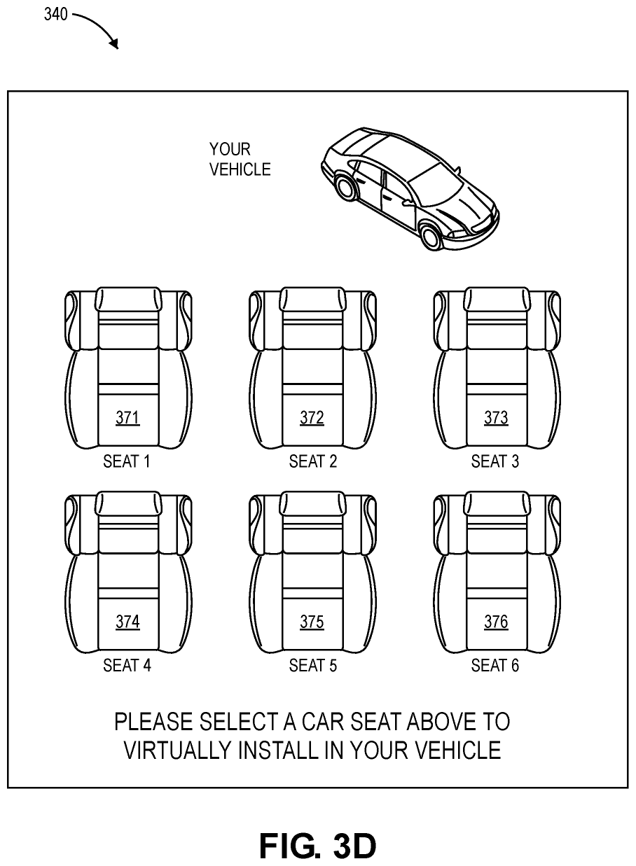

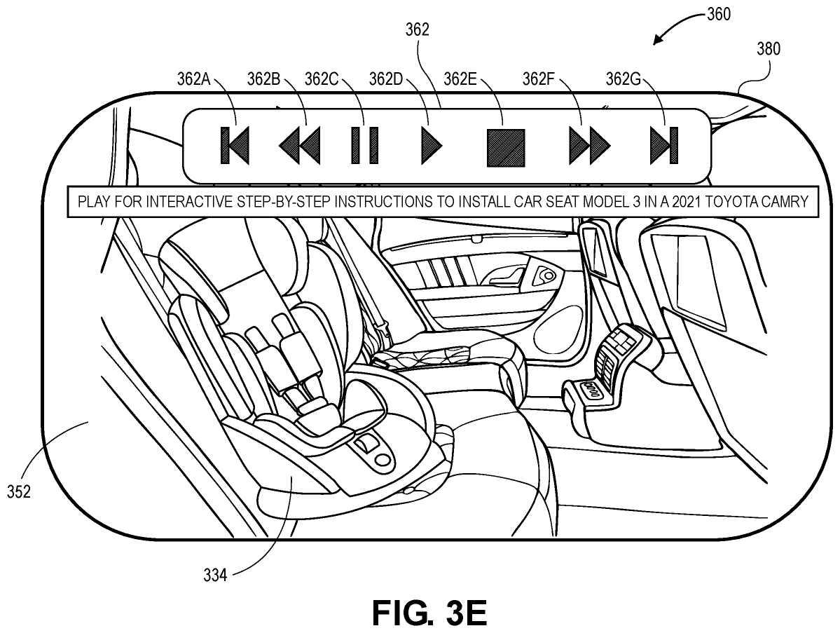

FIG. 3A depicts an exemplary computer system 300 for simulating a vehicle seat using AR and VR, in which the techniques described herein may be implemented, according to some embodiments. The system 300 may include a PV 302, AR device 330 (such as the AR devices 110, 230), a VR device 380 (such as the VR devices 150, 280), a network 320 (such as the network 220), and a server 310 (such as the server 210) that includes a database 312 (such as the database 212). While FIG. 3A depicts the AR device 330 as having an AR glasses form factor and the VR device 380 as having a head-mounted display (HMD) form factor, in other embodiments, the AR device 330 and/or the VR device 380 may have other form factors. The system may additionally or alternatively include one or more MR or XR devices.

The AR device 330 may have a transparent display via which the disclosed AR techniques are implemented. The AR device 330 may have one or more cameras and/or sensors (e.g., accelerometers, gyroscopes, etc.) via which the AR device 330 may determine a field of view 332 and/or a position of the AR device 330 relative to the PV 302. The AR device 330 may record and display the physical environment with augmented information overlaid thereupon thereby creating a virtual configuration. The VR device 380 may have one or more cameras and/or sensors (e.g., accelerometers, gyroscopes, etc.) which may determine, inter alia, the pose of the user's head. The VR device 380 may display a virtual configuration of an entirely virtual environment.

In the example shown in FIG. 3B, an AR virtual configuration 338 includes a VVSM 334 overlaid on the PV 302 by AR device 330, as further described below. In one embodiment, the virtual configuration 338 and/or the VVSM 334 included therein may be generated and/or provided by the server 310 via the network 320. In the example according to FIG. 3C, a VR virtual configuration 350 includes the VVM 352 and the VVSM 334. In one embodiment, the VR virtual configuration 350 may also be generated and/or hosted at the server 310. In these examples, the server 310 may interpret the orientation data received from the VR device 380 to determine a perspective of the user within a virtual configuration that includes the VVSM 334 and the VVM 352 representative of the PV 302. Accordingly, the server 310 may then transmit, via network 320, visual data representative of the virtual configuration 350 to the VR device 380 for presentation thereat.

In certain embodiments, the user may interact with a virtual configuration by manipulating the VVSM 334 in various ways, e.g., using hand tracking to virtually pick up the VVSM 334 and place it relative to a PV 302 in which the AR virtual configuration is overlaid, or within a VVM 352 according to a VR virtual configuration, however, a user may interact with and/or manipulate a VVSM 334 via any number of user interfaces techniques as described herein, such as a wand, a glove, a hand controller, a touchscreen, eye tracking, to name but a few.

According to one embodiment, the server 310 may be configured to receive a vehicle indicator associated with the PV 302. In one example, the vehicle indicator may include one or more of a vehicle make, a vehicle model, or one or more images of the PV 302. For example, the AR device 330 and/or the VR device 380 may be configured to provide a listing of vehicle makes and models for selection by the user (e.g., by speaking the make and model and/or by interacting with a virtual user interface element). In this example, the vehicle indicator may include an indication of the selected make and/or model of the selected vehicle. As another example, the AR device 330 and/or the VR device 380 may be configured to capture one or more images of the PV 302. In this example, the AR device 330 and/or the VR device 380 may be configured to analyze the image data to automatically detect the make and/or model of the PV 302 and transmit the corresponding vehicle indicator. Alternatively, the AR device 330 and/or the VR device 380 may be configured to transmit the captured image data to the server 310 for analysis thereat. For example, the server 310 may use artificial intelligence, machine learning, neural networks, machine vision, computer vision, and/or any other suitable image analysis techniques to derive a vehicle make and/or model based upon image data.

In certain embodiments where the server 310 supports VR techniques, the server 310 may use the vehicle indicator to query the database 312 to obtain a VVM 352 associated with the PV 302. In response, the server 310 may include the VVM 352 in a virtual configuration being presented via the VR device 380. For example, the server 310 may generate a new virtual environment that enables the user of the VR device 380 to explore and/or interact with the VVM 352 of the PV 302. As another example, the server 310 may update a virtual environment currently being explored by the user of the VR device 380 to include the VVM 352 of the PV 302. As described herein, the virtual configuration may also include a VVSM 334 of a vehicle seat.

In some embodiments, the AR device 330 and/or the VR device 380 may be configured to transmit a PVS indicator to the server 310. FIG. 3D depicts an exemplary virtual configuration 340 presented on the display of the AR device 330 and/or the VR device 380 via which one or more PVSs 371, 372, 373, 374, 375, 376 may be selected. Accordingly, the AR device 330 and/or the VR device 380 may detect the user selection of a PVS in a similar manner to detecting the vehicle indicator, e.g., via a voice command, virtually selecting a PVS using eye tracking, hand tracking, a hand controller, and/or any other suitable technique. In response to detecting a selection of a particular PVS, the AR device 330 and/or the VR device 380 may generate and transmit a PVS indicator that indicates the selected the PVS. For example, the PVS indicator may indicate a vehicle seat model (e.g., the ACME Baby Seat Plus).

In other embodiments, the server 310 may instead receive a request for a recommendation of one or more PVSs. In these embodiments, the server 310 may analyze characteristics of the PV 302, the PVS models stored in the database 312, and/or user preferences to recommend a PVS for use in the PV 302. The analysis may include excluding PVS models that do not fit in the PV 302 and/or are not compliant with the user preferences. Some examples of user preferences may include a price range, a brand, an installation location within the vehicle, as well as any other suitable preferences. In some embodiments, the server 310 may utilize a trained machine learning model to generate the recommendation of one or more PVSs. One such recommendation model is disclosed in U.S. Provisional Application No. 63/422,570, the entire disclosure of which is hereby incorporated by reference.

In certain embodiments that utilize the recommendation model, the server 310 may obtain a ranked list of PVS to recommend to the user. In some embodiments, the PVSs 371-376 depicted in the virtual configuration 340 correspond to the top results in the ranked list. Alternatively, the server 310 may utilize the top-ranked result as the PVS indicator.

In response to obtaining the PVS indicator, the server 310 may query the database 312 to obtain a VVSM 334 that corresponds to the indicated PVS. In response, the server 310 may update a virtual configuration presented via the AR device 330 and/or the VR device 380 to include the VVSM 334. For example, in one VR embodiment, the server 310 may update the virtual configuration such that the VVSM 334 is placed upon a seat of the VVM 352, as depicted in FIG. 3C. As a result, the virtual environment of which the virtual configuration represents includes a virtual representation of the expected fit of the indicated PVS when installed into the PV 302.

On the other hand, in one AR embodiment, the server 310 may transmit the VVSM 334 to the AR device 330 for presentation thereat. More particularly, the AR device 330 may analyze the image data of the PV 302 to overlay the VVSM 334 on the PV 302 in a manner that accounts for the perspective of the user and the physical dimensions of the PV 302. That is, the AR device 330 may be configured to detect the physical location of the seat of the PV 302 and scale, rotate, and/or otherwise modify the VVSM 334 such that the virtual configuration virtually depicts the expected fit of the indicated PVS when installed into the PV 302.

In some embodiments, the user may be able to select a particular arrangement of the VVSM 334 in the PV 302. For example, the user may be able to select the particular seat and/or row of seats in which the PVS will be installed. Accordingly, in these embodiments, the server 310 and/or AR device 330 may be configured to analyze the selected arrangement to generate a virtual configuration that reflects the indicated seat arrangement.

After generating a virtual configuration that includes the VVSM 334, the server 310 and/or the AR device 330 may analyze the fit of the VVSM 334 in the PV 302 to provide guidance to the user. With simultaneous reference to FIG. 3B, illustrated is an exemplary virtual configuration 338 presented by the AR device 330. As illustrated, the virtual configuration 338 includes a VVSM 334 overlaid on the rear passenger-side seat of the PV 302.

In the illustrated scenario, the AR device 330 may determine a clearance between the end of the VVSM 334 and the back of the front passenger-side seat. To this end, because the size of the VVSM 334 and the position of the rear passenger-side seat of the PV 302 is known, the AR device 330 is able to determine a position of the end of the VVSM 334 in the PV 302. Additionally, the AR device 330 may be configured to analyze the image data to determine a position of the back of the front passenger-side seat of the PV 302. It should be appreciated that this determination may occur dynamically, allowing the user to adjust the recline setting of the front passenger-side seat. As such, the user may be able to estimate how much the front passenger-side may be reclined while still accommodating the PVS corresponding to the VVSM 334.

After determining the amount of clearance, the AR device 330 may update the virtual configuration to include an indication 336 (i.e., fit information) of the amount of clearance. Other clearance information may also be provided, e.g., the clearance distance between the PVS and the back of the driver's seat, the roof of the vehicle, a center arm rest, the passenger door, etc. In one embodiment, the user may be able to indicate and/or otherwise interact with the indication 336 of fit information, e.g., placing a thumb on the VVSM 334 and index finger on the vehicle roof may indicate fit information therebetween.

It should be appreciated that in embodiments where the server 310 implements VR techniques, the server 310 may know the position of the VVSM 334 and the VVM 352 as part of generating the virtual environment. Accordingly, the server 310 may be able to dynamically determine the amount of clearance based upon data provided by the virtual environment engine.

While the indication 336 pertains to an amount of clearance, additional virtual indications may indicate other data. For example, the AR device 330 and/or the server 310 may determine that the current configuration of the VVSM 334 does not fit in the PV 302 and/or the VVM 334 thereof. As another example, the AR device 330 and/or the server 310 may determine the PVS corresponding to the VVSM 334 will not be properly supported due to insufficient depth of the rear seat of the PV 302 which the VVSM 334 is placed upon.

In addition to the analysis of the fit of the VVSM 334, the AR device 330 and/or the VR device 380 may be configured to present installation instructions on how to properly install the PVS corresponding to the VVSM 334. With simultaneous reference to FIG. 3E, illustrated is an exemplary virtual configuration 360 presented by the VR device 380. As illustrated the virtual configuration 360 includes a VVSM 334 within a VVM 352.

In some embodiments, the server 310 may associate the VVSMs maintained in the database 312 with virtual installation instructions. Accordingly, in response to detecting a request to present installation instructions from the VR device 380, the server 310 may obtain the virtual installation instructions corresponding to the VVSM 334 included in the virtual configuration 360.

The virtual installation instructions may include sound, text, graphics, animations, video, multimedia, as well as any other suitable instructions for installing the PVS corresponding to the VVSM 334 in the PV 302. For example, the VR device 380 may present an instruction control interface 362 via which the user is able to control playback of the instructions. The control interface 362 may include one or more interface elements, including a play element 362D, a pause element 362C, a stop element 362E, a fast-forward element 362F, a rewind element 362B, a skip-step element 362G, a previous step element 362A, a playback speed element, a video scrubbing element, a selected camera point-of-view (POV) element, as well as any other suitable playback commands which may affect the presentation of the virtual installation instructions. In one embodiment, the user may indicate one or more playback commands from the control interface 362 via a user interface device, such as voice control, hand tracking, eye tracking, a hand controller, or any other suitable user interface methods as described herein.

In certain embodiments in which the server 310 implements AR techniques, the server 310 may automatically control the presentation of the virtual installation instructions based upon image data received from the AR device 330. For example, the user may install the PVS corresponding to the VVSM 334 in the PV 302 while viewing the virtual installation instructions to obtain dynamic guidance during the installation process. Accordingly, the server 310 may detect that the user has completed a step of the installation process (e.g., clipping a base unit of the PVS to a vehicle anchor, tethering the base unit of the PVS to the vehicle, securing the tether, etc.) and automatically present a subsequent installation instruction.

Additionally, the AR device 330 and/or the VR device 380 may be configured to provide uninstallation instructions for a PVS installed in the PV 302. In one example, the cameras of the AR device 330 and/or the VR device 380 may capture images of the installed PVS and transmit the images to the server 310. In response, the server 310 may identify the PVS based upon the images. For example, the server 310 may determine a make and/or model of the PVS using object recognition. As another example, the user may input the make and/or model via a user interface.

After the PVS is identified, the server 310 may query the database 312 to retrieve virtual instructions to install the corresponding PVS in the PV 302. Alternatively, in some embodiments, the server 310 may retrieve instructions to uninstall the identified PVS. Regardless, the server 310 may be transmit the instructions to the AR device 330 and/or the VR device 380 for presentation thereat.

In another embodiment, the server 310 may further include obtaining one or more (non-virtual) installation instructions associated with the indicated PVS from one or more of an online resource, a product manual, specification data, one or more images, and may generate the one or more virtual installation instructions therefrom, however, virtual instructions may be generated by the server 310 in any suitable manner. In one embodiment, the virtual installation instructions may include step-by-step virtual instructions with videos, models and/or other multimedia. For example, the server 310 may obtain a digital document including textual and graphical installation instructions and convert the instruction data into virtual installation instructions to be transmitted in a virtual configuration to the display of the AR device 330 and/or VR device 380, as well as stored in the database 312.

In one embodiment, the virtual installation instructions may be illustrative of installing any make and/or model of the PVS in the indicated PV; installing the indicated PVS in any make and/or model of the PV; installing the PVS in the PV without an indication of make and/or model of the PVS or the PV; and/or installing specific makes and/or models of a vehicle and vehicle seat in a virtual configuration.

The system 300 may include additional, fewer, and/or alternate components, and may be configured to perform additional, fewer, or alternate actions, including components/actions described herein.

### Exemplary Computer-Implemented Method for Simulating a Vehicle Seat in a Vehicle Using Ar

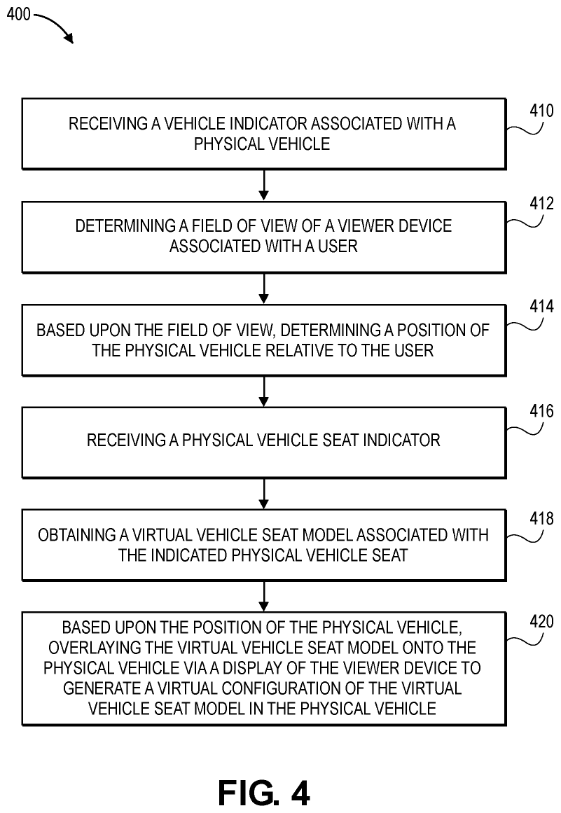

FIG. 4 depicts a flow diagram of an exemplary computer-implemented method 400 for simulating a vehicle seat in a vehicle using AR, according to one embodiment. One or more steps of the method 400 may be implemented as a set of instructions stored on a computer-readable memory and executable on one or more processors. The method 400 of FIG. 4 may be implemented via an AR device, such as AR devices 100, 330. In some embodiments, the AR device may include a separate base unit and a viewer device. In other embodiments, the AR device is a viewer device that integrates the base unit functionality into the viewer device itself.

The computer-implemented method 400 may include (1) at block 410 receiving, by one or more processors, a vehicle indicator associated with a PV (such as the PV 302); (2) at block 412 determining, via the one or more processors, a field of view of a viewer device associated with a user; (3) at block 414 based upon the field of view, determining, by the one or more processors, a position of the PV relative to the user; (4) at block 416 receiving, by the one or more processors, a PVS indicator; (5) at block 418 obtaining, by the one or more processors, a VVSM (such as the VVSM 334) associated with the indicated PVS; and (6) at block 420 based upon the position of the PV, overlaying, via the one or more processors, the VVSM onto the PV via a display of the viewer device to generate a virtual configuration (such as the virtual configuration 338) of the VVSM in the PV.

In one embodiment of the computer-implemented method 400, the vehicle indicator may include one or more of a vehicle make, a vehicle model, and/or one or more images of the PV.

In one embodiment of the computer-implemented method 400, receiving the PVS indicator at block 416 may include receiving, by the one or more processors, the PV indicator as an output of a trained machine learning model, wherein the trained machine learning model may be trained using a set of characteristics of recommended vehicle seats.

In one embodiment of the computer-implemented method 400, receiving the PVS indicator at block 416 may include receiving, by one or more processors, a request for a recommendation of one or more PVSs; and/or processing, by the one or more processors, the vehicle indicator and user seat preferences by a trained machine learning model to generate the recommendation of one or more PVSs. The trained machine learning model may be trained using a set of characteristics of one or more PVSs; and/or the PVS indicator may be based upon the one or more PVS recommendations.

In one embodiment, the computer-implemented method 400 may include obtaining, by the one or more processors, one or more virtual installation instructions associated with the indicated PVS; and/or presenting, via the one or more processors to the display of the viewer device, the one or more virtual installation instructions.

In one embodiment of the computer-implemented method 400, obtaining one or more virtual installation instructions associated with the indicated PVS may include obtaining, using one or more processors, one or more installation instructions associated with the indicated PVS from one or more of an online resource, a product manual, specification data, one or more images, and/or a machine learning model trained to generate installation instructions associated with the indicated PVS; and/or generating, by the one or more processors, one or more virtual installation instructions based upon the one or more installation instructions.

In one embodiment of the computer-implemented method 400, presenting the one or more virtual installation instructions may include receiving, by the one or more processors, a playback command indicating one or more of pause, fast-forward, rewind, skip-step, previous step, a playback speed, video scrubbing, forward 10 seconds, backward 10 seconds, and/or a camera POV; and/or implementing, via the one or more processors, the playback command with respect to the presentation of the one or more installation instructions.

The computer-implemented method 400 may include obtaining, by the one or more processors, physical seat model data that indicates physical characteristics of a PVS; and/or generating, by the one or more processors, the VVSM based upon the physical seat model data.

In one embodiment of the computer-implemented method 400, generating the virtual configuration of the VVSM in the PV of block 420 may include generating, by the one or more processors, fit information corresponding to the fit of the PVS in the PV based upon the virtual configuration of the VVSM in the PV; and/or overlaying, by the one or more processors, the fit information onto the virtual configuration via a display of the Viewer device.

In one embodiment of the computer-implemented method 400, generating the virtual configuration of the VVSM in the PV of block 420 may include identifying, by the one or more processors, one or more PVS configurations based upon the vehicle indicator; receiving, by the one or more processors, an indication of a PVS configuration from the one or more PVS configurations; and/or generating, by the one or more processors, the virtual configuration 338 of the virtual vehicle seat configuration model in the PV based upon the indication of the PVS configuration.

It should be understood that not all blocks of the exemplary flow diagram chart 400 are required to be performed. Moreover, the exemplary flow diagram 400 is not mutually exclusive (e.g., block(s) from example flowchart 400 may be performed in any particular implementation).

### Exemplary Computer-Implemented Method for Simulating a Vehicle Seat in a Vehicle Using VR

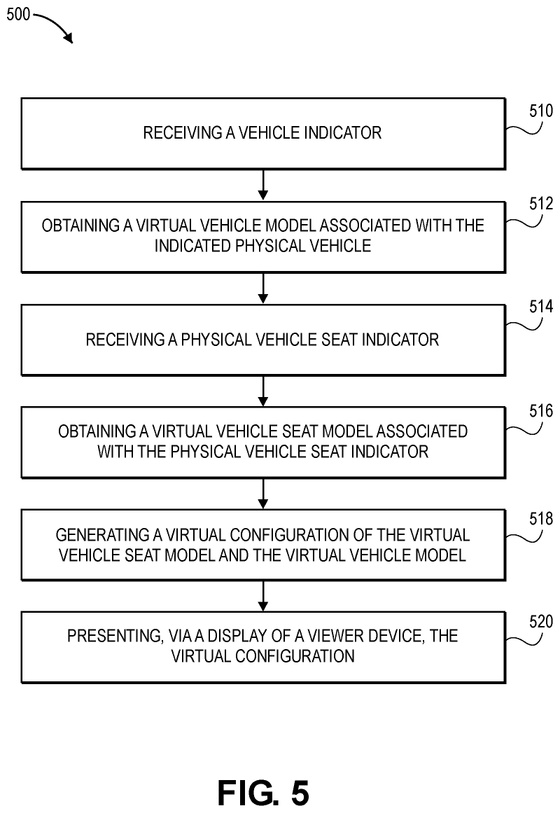

FIG. 5 depicts a flow diagram of an exemplary computer-implemented method 500 for simulating a vehicle seat in a vehicle using VR, according to one embodiment. One or more steps of the method 500 may be implemented as a set of instructions stored on a computer-readable memory and executable on one or more processors. The method 500 of FIG. 5 may be implemented via a VR device, such as VR device 150, 380. In some embodiments, the VR device may include a separate base unit and a viewer device. In other embodiments, the VR device is a viewer device that integrates the base unit functionality into the viewer device itself.

The computer-implemented method 500 for simulating a vehicle seat in a vehicle using virtual reality (VR), may include (1) at block 510 receiving, by one or more processors, a vehicle indicator; (2) at block 512 obtaining, by the one or more processors, a VVM (such as VVSM 352) associated with the indicated PV (such as PV 302); (3) at block 514 receiving, by the one or more processors, a PVS indicator; (4) at block 516 obtaining, by the one or more processors, a VVSM (such as VVSM 334) associated with the PVS indicator; (5) at block 518 generating, by the one or more processors, a virtual configuration (such as virtual configuration 350) of the VVSM and the VVM; and/or (6) at block 520 presenting, via a display of the (VR) viewer device, the virtual configuration. The method may include additional, less, or alternate actions, including those discussed elsewhere herein.

For instance, in one embodiment of the computer-implemented method 500, the vehicle indicator may include one or more of a vehicle make, a vehicle model, and/or one or more vehicle images.

In one embodiment of the computer-implemented method 500, receiving the PVS indicator of step 514 may include receiving, by the one or more processors, the vehicle seat indicator as an output of a trained machine learning model. The trained machine learning model may be trained using a set of characteristics of recommended vehicle seats.

In one embodiment of the computer-implemented method 500, receiving the PVS indicator of step 514 may include receiving, by one or more processors, a request for a recommendation of one or more PVSs; and/or processing, by the one or more processors, the vehicle indicator and user seat preferences by a trained machine learning model to generate the recommendation of one or more PVSs. The trained machine learning model may be trained using a set of characteristics of one or more PVSs; and/or the PVS indicator may be based upon the one or more PVS recommendations.

The computer-implemented method 500 may include obtaining, by the one or more processors, physical seat model data that indicates physical characteristics of a PVS; and/or generating, by the one or more processors, the VVSM based upon the physical seat model data.

In one embodiment, the computer-implemented method 500 may include obtaining, by the one or more processors, one or more virtual installation instructions associated with the indicated PVS; and/or presenting, via the display of the VR device, the one or more virtual installation instructions.

In one embodiment of the computer-implemented method 500, presenting the one or more virtual installation instructions may include receiving, by the one or more processors, a playback command indicating one or more of pause, fast-forward, rewind, skip-step, previous step, a playback speed, video scrubbing, forward 10 seconds, backward 10 seconds, and/or a camera POV; and/or implementing, by the one or more processors, the playback command with respect to the presentation of the one or more installation instructions.

In one embodiment of the computer-implemented method 500, obtaining one or more virtual installation instructions associated with the indicated PVS may include obtaining, using one or more processors, one or more installation instructions associated with the indicated PVS from one or more of an online resource, a product manual, specification data, one or more images, and/or a machine learning model trained to generate installation instructions associated with the indicated PVS; and/or generating, by the one or more processors, one or more virtual installation instructions based upon the one or more installation instructions.

In one embodiment of the computer-implemented method 500, generating a virtual configuration of step 518 may include identifying, by the one or more processors, one or more PVS configurations based upon the vehicle indicator; receiving, by the one or more processors, a PVS configuration indicator from the one or more PVS configurations; and/or generating, the virtual configuration based upon the indicated PVS configuration indicator.

In one embodiment of the computer-implemented method 500, presenting the virtual configuration of step 520 may include generating, by the one or more processors, fit information corresponding to the fit of the PVS in the PV based upon the virtual configuration of the VVSM and the VVM; and/or presenting, by the one or more processors, the fit information and the virtual configuration via the display of the viewer device.

It should be understood that not all blocks of the exemplary flow diagram 500 are required to be performed. Moreover, the exemplary flowchart 500 is not mutually exclusive (e.g., block(s) from exemplary flow diagram 500 may be performed in any particular implementation).

### ADDITIONAL CONSIDERATIONS

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In certain embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “one embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

In certain embodiments, the systems and methods may apply machine learning. In these embodiments a system may store and/or execute one or more applications (e.g., via server in memory) for machine learning, which may include storing historical data used to train the machine learning model, as well as the trained machine learning model itself.

Whether a machine learning model is trained on the computing system or elsewhere, the machine learning model may be trained by a machine learning model training application using training data corresponding to historical data. The trained machine learning model may then be applied to data in order to determine one or more embodiments relevant to simulating a vehicle seat in a vehicle.

In various embodiments, the machine learning model may comprise a machine learning program or algorithm that may be trained by and/or employ a neural network, which may be a deep learning neural network, or a combined learning module or program that learns in one or more features or feature datasets in particular area(s) of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques.

In some embodiments, the artificial intelligence and/or machine learning based algorithms used to train the machine learning model may comprise a library or package executed on the computing system (or other computing devices). For example, such libraries may include the TENSORFLOW based library, the PYTORCH library, and/or the SCIKIT-LEARN Python library.

Machine learning techniques disclosed herein may involve identifying and recognizing patterns in existing historical data in order to facilitate making predictions or identification for subsequent data. Machine learning model(s) may be created and trained based upon example data (e.g., “training data”) inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based upon the discovered rules, relationships, or model, an expected output.

In unsupervised machine learning, a server otherwise processor(s), may be required to find structure in unlabeled example inputs, where, for example multiple training iterations are executed by the server or otherwise processor(s) to train multiple generations of models until a satisfactory model, e.g., a model that provides sufficient prediction accuracy when given test level or production level data or inputs, is generated. The disclosures herein may use one or both of such supervised or unsupervised machine learning techniques. The supervised and/or unsupervised machine learning techniques may be followed by and/or otherwise used in conjunction with reinforced or reinforcement learning.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for simulating a vehicle seat in a vehicle using augmented reality (AR), comprising:
receiving, by one or more processors, a vehicle indicator associated with a physical vehicle;
determining, via the one or more processors, a field of view of a viewer device associated with a user;
based upon the field of view, determining, by the one or more processors, a position of the physical vehicle relative to the user;
receiving, by the one or more processors, a physical vehicle seat indicator;
obtaining, by the one or more processors, a virtual vehicle seat model associated with the indicated physical vehicle seat; and
based upon the position of the physical vehicle, overlaying, via the one or more processors, the virtual vehicle seat model onto the physical vehicle via a display of the viewer device to generate a virtual configuration of the virtual vehicle seat model in the physical vehicle.

2. The computer-implemented method of claim 1, wherein the vehicle indicator includes one or more of a vehicle make, a vehicle model, or one or more images of the physical vehicle.

3. The computer-implemented method of claim 1, further comprising:
obtaining, by the one or more processors, one or more virtual installation instructions associated with the indicated physical vehicle seat; and
presenting, via the one or more processors to the display of the viewer device, the one or more virtual installation instructions.

4. The computer-implemented method of claim 3, wherein presenting the one or more virtual installation instructions comprises:
receiving, by the one or more processors, a playback command indicating one or more of pause, fast-forward, rewind, skip-step, previous step, a playback speed, video scrubbing, forward 10 seconds, backward 10 seconds, or a camera POV; and
implementing, via the one or more processors, the playback command with respect to the presentation of the one or more installation instructions.

5. The computer-implemented method of claim 3, wherein obtaining the one or more virtual installation instructions associated with the indicated physical vehicle seat comprises:
obtaining, using one or more processors, one or more installation instructions associated with the indicated physical vehicle seat from one or more of an online resource, a product manual, specification data, one or more images, and/or a machine learning model trained to generate installation instructions associated with the indicated physical vehicle seat; and
generating, by the one or more processors, the one or more virtual installation instructions based upon the one or more installation instructions.

6. The computer-implemented method of claim 1, further comprising:
obtaining, by the one or more processors, physical seat model data that indicates physical characteristics of a physical vehicle seat; and
generating, by the one or more processors, the virtual vehicle seat model based upon the physical seat model data.

7. The computer-implemented method of claim 1, wherein receiving the physical vehicle seat indicator comprises:
receiving, by the one or more processors, the physical vehicle seat indicator as an output of a trained machine learning model, wherein the trained machine learning model is trained using a set of characteristics of recommended vehicle seats.

8. The computer-implemented method of claim 1, wherein receiving the physical vehicle seat indicator comprises:
receiving, by one or more processors, a request for a recommendation of one or more physical vehicle seats; and
processing, by the one or more processors, the vehicle indicator and user seat preferences by a trained machine learning model to generate the recommendation of one or more physical vehicle seats, wherein:
the trained machine learning model is trained using a set of characteristics of one or more physical vehicle seats; and
the physical vehicle seat indicator is based upon the one or more physical vehicle seat recommendations.

9. The computer-implemented method of claim 1, wherein generating the virtual configuration of the virtual vehicle seat model in the physical vehicle comprises:
generating, by the one or more processors, fit information corresponding to the fit of the physical vehicle seat in the physical vehicle based upon the virtual configuration of the virtual vehicle seat model in the physical vehicle; and
overlaying, by the one or more processors, the fit information onto the virtual configuration via a display of the viewer device.

10. The computer-implemented method of claim 1, wherein generating the virtual configuration of the virtual vehicle seat model in the physical vehicle comprises:
identifying, by the one or more processors, one or more physical vehicle seat configurations based upon the vehicle indicator;
receiving, by the one or more processors, an indication of a physical vehicle seat configuration from the one or more physical vehicle seat configurations; and
generating, by the one or more processors, the virtual configuration based upon the indicated physical vehicle seat configuration.

11. A computer system for simulating a vehicle seat in a vehicle using augmented reality (AR), the system comprising:
one or more processors; and
one or more non-transitory memories storing processor-executable instructions that, when executed by the one or more processors, cause the system to:
receive a vehicle indicator associated with a physical vehicle;
determine a field of view of a viewer device associated with a user;
based upon the field of view, determine a position of the physical vehicle relative to the user;
receive a physical vehicle seat indicator;
obtain a virtual vehicle seat model associated with the indicated physical vehicle seat; and
based upon the position of the physical vehicle, overlay the virtual vehicle seat model onto the physical vehicle via a display of the viewer device to generate a virtual configuration of the virtual vehicle seat model in the physical vehicle.

12. The system of claim 11, wherein the vehicle indicator includes one or more of a vehicle make, a vehicle model, or one or more images of the physical vehicle.

13. The system of claim 11, further comprising instructions that, when executed, cause the system to:
obtain one or more virtual installation instructions associated with the indicated physical vehicle seat; and
present to the display of the viewer device, the one or more virtual installation instructions.

14. The system of claim 13, wherein to present the one or more virtual installation instructions, the instructions, when executed, cause the system to:
receive a playback command indicating one or more of pause, fast-forward, rewind, skip-step, previous step, a playback speed, video scrubbing, forward 10 seconds, backward 10 seconds, or a camera POV; and
implement the playback command with respect to the presentation of the one or more installation instructions.

15. The system of claim 13, wherein to obtain the one or more virtual installation instructions associated with the indicated physical vehicle seat, the instructions, when executed, cause the system to:
obtain one or more installation instructions associated with the indicated physical vehicle seat from one or more of an online resource, a product manual, specification data, one or more images, and/or a machine learning model trained to generate installation instructions associated with the indicated physical vehicle seat; and
generate the one or more virtual installation instructions based upon the one or more installation instructions.

16. The system of claim 11, further comprising instructions that, when executed, cause the system to:
obtain physical seat model data that indicates physical characteristics of a physical vehicle seat; and
generate the virtual vehicle seat model based upon the physical seat model data.

17. The system of claim 11, wherein to receive the physical vehicle seat indicator, the instructions, when executed, cause the system to:
receive the physical vehicle seat indicator as an output of a trained machine learning model, wherein the trained machine learning model is trained using a set of characteristics of recommended vehicle seats.

18. The system of claim 11, wherein to receive the physical vehicle seat indicator, the instructions, when executed, cause the system to:
receive a request for a recommendation of one or more physical vehicle seats; and
process the vehicle indicator and user seat preferences by a trained machine learning model to generate the recommendation of one or more physical vehicle seats, wherein:
the trained machine learning model is trained using a set of characteristics of one or more physical vehicle seats; and
the physical vehicle seat indicator is based upon the one or more physical vehicle seat recommendations.

19. The system of claim 11, wherein to generate the virtual configuration of the virtual vehicle seat model in the physical vehicle, the instructions, when executed, cause the system to:
identify one or more physical vehicle seat configurations based upon the vehicle indicator;
receive an indication of a physical vehicle seat configuration indicator from the one or more physical vehicle seat configurations; and
generate the virtual configuration based upon the indicated physical vehicle seat configuration.

20. A non-transitory computer-readable medium storing processor-executable instructions that, when executed by one or more processors, cause the one or more processors to:
receive a vehicle indicator associated with a physical vehicle;
determine a field of view of a viewer device associated with a user;
based upon the field of view, determine a position of the physical vehicle relative to the user;
receive a physical vehicle seat indicator;
obtain a virtual vehicle seat model associated with the indicated physical vehicle seat; and
based upon the position of the physical vehicle, overlay the virtual vehicle seat model onto the physical vehicle via a display of the viewer device to generate a virtual configuration of the virtual vehicle seat model in the physical vehicle.
